(19) United States
(12) Patent Application Publication
(10) Pub. No.: US 2020/0118116 A1
(43) Pub. Date: Apr. 16, 2020

(54) SECURITY-BACKED CRYPTOCURRENCY METHODS AND SYSTEMS

(71) Applicant: Rajeev Gupta, PLEASANTON, CA (US)

(72) Inventor: Rajeev Gupta, PLEASANTON, CA (US)

(21) Appl. No.: 16/392,596

(22) Filed: Apr. 23, 2019

Related U.S. Application Data
(60) Provisional application No. 62/661,085, filed on Apr. 23, 2018.

(51) Int. Cl. G06Q 20/36; H04L 9/06; G06Q 20/38; G06Q 40/04; G06Q 20/32

(52) U.S. Cl. CPC G06Q 20/3674; H04L 9/0637; H04L 2209/38; G06Q 40/04; G06Q 20/3223; G06Q 20/3825

(57) ABSTRACT

In one aspect, a computerized method useful for implementing security-backed cryptocurrency comprises: implementing various user verifications/registrations enable a user to provide the user's banking account details a user can purchase the SECURECOIN; generating SECURECOIN using specified block-chain systems; depositing a specified percentage (X %) of the purchases in fiat/crypto to a bank account; setting 100-X % of the purchases equity at next market price; adjusting reserves based on reserve equity; notifying a specified trust authority and/or update information on a public web site providing SECURECOIN-related information; and adjusting reserves by selling equity to match a token cost basis; detecting when a bank account falls below Y % of net asset.

### CROSS-REFERENCE TO RELATED APPLICATIONS

This application claims priority to U.S. provisional patent application No. 62/661,085, titled SECURITY-BACKED CRYPTOCURRENCY METHODS AND SYSTEMS and filed on Apr. 23, 2019. This application is hereby incorporated by reference in its entirety.

### BACKGROUND

### 1. Field

This application relates generally to crypto currency, and more particularly to a system, method and article of manufacture of security-backed cryptocurrency methods.

### 2. Related Art

Improvements to crypto currency systems are desired.

### BRIEF SUMMARY OF THE INVENTION

In one aspect, a computerized method useful for implementing security-backed cryptocurrency comprises: implementing various user verifications/registrations enable a user to provide the user's banking account details a user can purchase the SECURECOIN; generating SECURECOIN using specified block-chain systems; depositing a specified percentage (X %) of the purchases in fiat/crypto to a bank account; setting 100-X % of the purchases equity at next market price; adjusting reserves based on reserve equity; notifying a specified trust authority and/or update information on a public web site providing SECURECOIN-related information; and adjusting reserves by selling equity to match a token cost basis; detecting when a bank account falls below Y % of net asset.

### BRIEF DESCRIPTION OF THE DRAWINGS

The present application can be best understood by reference to the following description taken in conjunction with the accompanying figures, in which like parts may be referred to by like numerals.

FIG. 1 schematically depicts a security-backed cryptocurrency process, according to some embodiments.

FIGS. 2 A-B illustrate an example process of a SECURECOIN flow in a centralized and/or decentralized trading network, according to some embodiments.

FIG. 3 illustrates an example process for implementing a stop loss order on a secure token/coin (e.g. SECURECOIN, etc.), according to some embodiments.

FIG. 4 illustrates an example process for implementing a blockchain workflow engine, according to some embodiments.

FIGS. 5 A-B illustrate an example process for implementing blockchain ERP integration, according to some embodiments.

FIG. 6 is a block diagram of a sample computing environment that can be utilized to implement some embodiments.

The Figures described above are a representative set and are not an exhaustive with respect to embodying the invention.

### DESCRIPTION

Disclosed are a system, method, and article of a security-backed cryptocurrency. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Definitions

Blockchain is a continuously growing list of records, called blocks, which are linked and secured using cryptography. Each block typically contains a cryptographic hash of the previous block, a timestamp and transaction data.

Cryptocurrency can be a digital asset designed to work as a medium of exchange that uses cryptography to secure its transactions, to control the creation of additional units, and to verify the transfer of assets.

Enterprise resource planning (ERP) is the integrated management of core business processes, often in real-time and mediated by software and technology.

Various blockchain consensus algorithms can be utilized. Proof-of-authority (PoA) is an algorithm used with blockchains that delivers comparatively fast transactions through a consensus mechanism based on identity as a stake. PoA uses identity as the sole verification of the authority to validate, meaning that there is no need to use mining. With PoA, the appointment of an authority is automatic, meaning that there can be no bias or uneven process caused by unequal stakes. In PoA, validators need to have their identity verified formally (e.g. via DApps) and have this identity information available in the public domain for everyone to cross-reference.

Proof-of-work (PoW) consensus uses a mining mechanism. PoW can use a mining and computer power-based system in which participating users are required to solve difficult mathematical problems to validate and authenticate transactions. PoW works by verifying that work (mining) has been done before transactions are carried out.

Proof-of-stake (PoS) mechanism works using an algorithm that selects participants with the highest stakes as validators, assuming that the highest stakeholders are incentivized to ensure a transaction is processed. PoS can derives from actual holdings of the cryptocurrency.

Delegated proof-of-stake (DPoS) works using witnesses, who generate blocks. Witnesses are elected by stakeholders at a rate of one vote per share per witness.

Stop-loss order can be a market order to close a position if/when losses reach a threshold.

Exemplary Processes

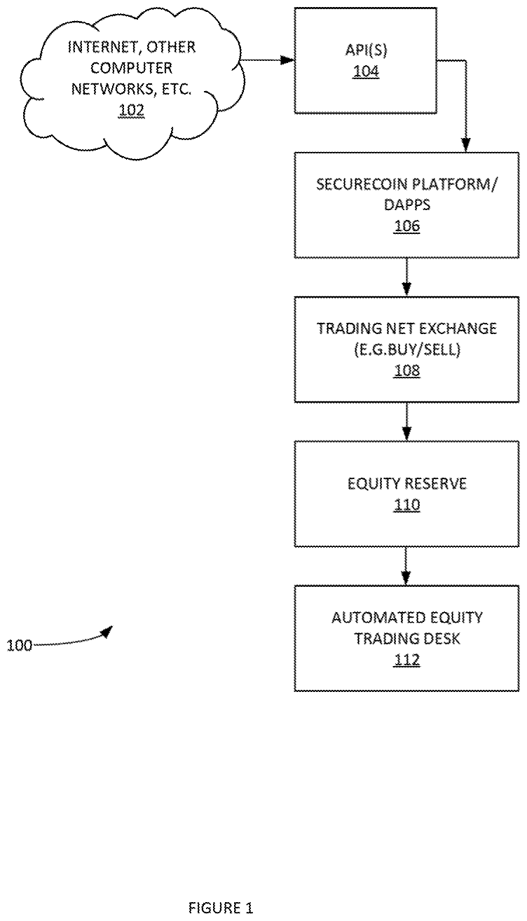

FIG. 1 schematically depicts a security-backed cryptocurrency process 100, according to some embodiments. Process 100 can utilize the Internet 102, APIs 104, etc. to interact with SECURECOIN platform/DAPPS 106. The SECURECOIN can be used on trading/network exchange 108. Equity reserve 110 can back the value of the SECURECOIN. An automated equity trading desk 112 can be implemented. It is noted that SECURECOIN can be a type of cryptocurrency with the attributes provided herein. For example, SECURECOIN can be a cryptocurrency that is backed by a security (e.g. a tradable financial asset such as an S&P 500 stock(s), etc.).

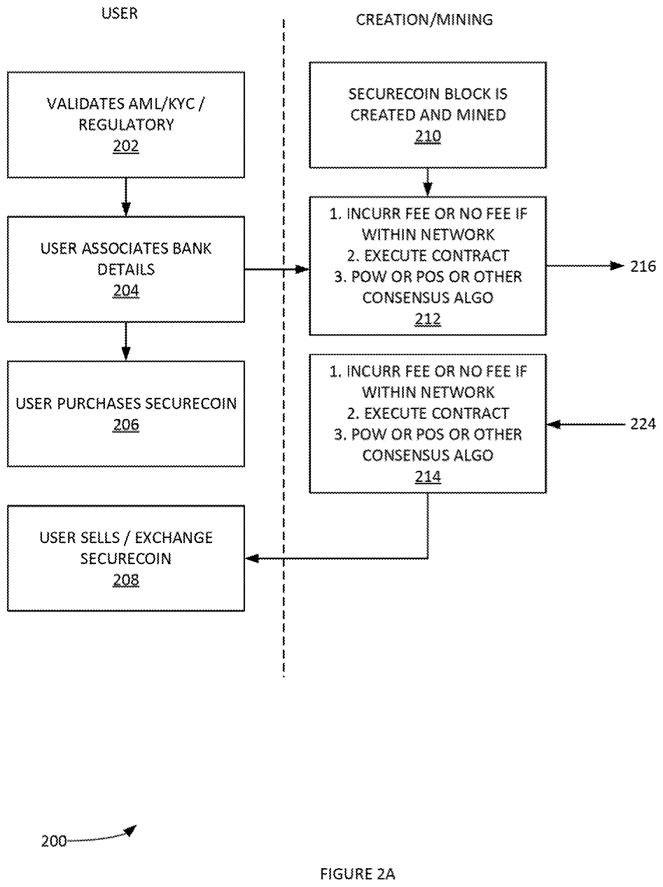

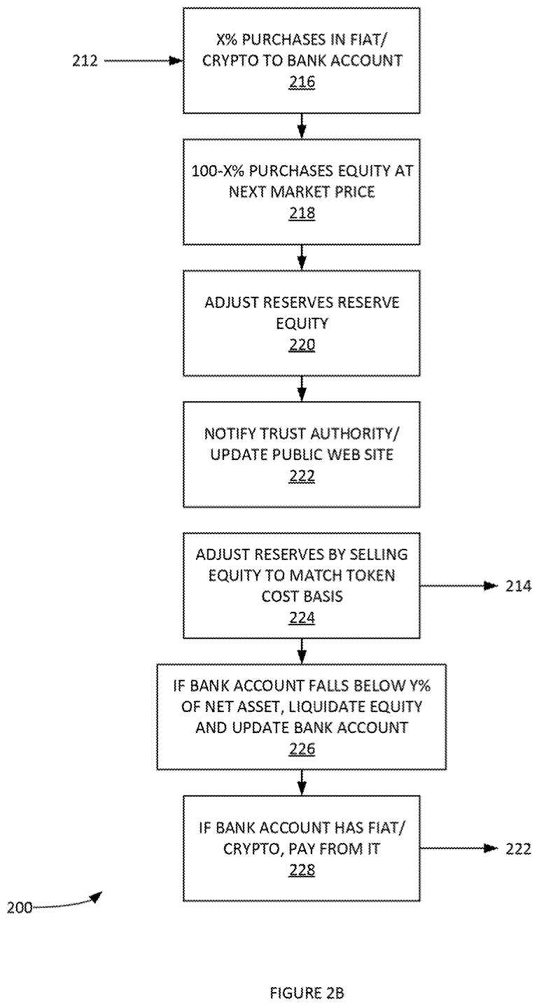

FIGS. 2 A-B illustrate an example process 200 of a SECURECOIN flow in a centralized and/or decentralized trading network, according to some embodiments. Process 200 can consist of steps automated by a computing system.

On the user side, in step 202, process 200 can implement various user verifications/registrations (e.g. validates using anti-money laundering (AML) systems, know your client (KYC) systems, etc.) and be associated with a bank account(s). In step 204, enable a user to provide the user's banking account details. In step 206, a user can purchase the SECURECOIN. Process 200 can proceed after step 204 to the SECURECOIN creation/mining portion of process 200.

In step 210, process 200 can generate SECURECOIN using specified block-chain systems. In step 212, process 200 can receive the user information. More specifically, in step 210, process 200 can implement a specific algorithm as shown. For example, step 210 can determine if the user incurs a fee or not (e.g. if the user is within the applicable network). Step 210 can execute the contract for the SECURECOIN purchase. Step 210 can implement a consensus algorithm (e.g. PoW, PoA, PoS, etc.) that is associated with the SECURECOIN. After step 212, process 200 can proceed to step 216.

In step 216, process 200 can deposit a specified percentage (X %) of the purchases in fiat/crypto to a bank account. This can a portion of the SECURECOIN value. For example, if one-hundred dollars of SECURECOIN is purchased, then ten percent can be put as a liquid asset in a reserve holding account (e.g. by a centralized company, a decentralized reserve holding system, etc.). The remaining ninety percent can then be swept out into an applicable equity market.

In step 218, 100-X % of the purchases equity can be set at next market price. In step 220, process 200 can adjust reserves based on reserve equity. In step 222, process 200 can notify a specified trust authority and/or update information on a public web site providing SECURECOIN-related information.

In step 224, process 200 can adjust reserves by selling equity to match a token cost basis. Process 200 can also move to step 214. In step 226, process 200 can detect when a bank account falls below Y % of net asset. When this is detected step 226 can liquidate a specified equity and update the relevant bank account information (e.g. maintain the 10/90 split of the above example, etc.). In step 228, if bank account has fiat/crypto, then process 200 can pay from it. Process 200 can return to step 222.

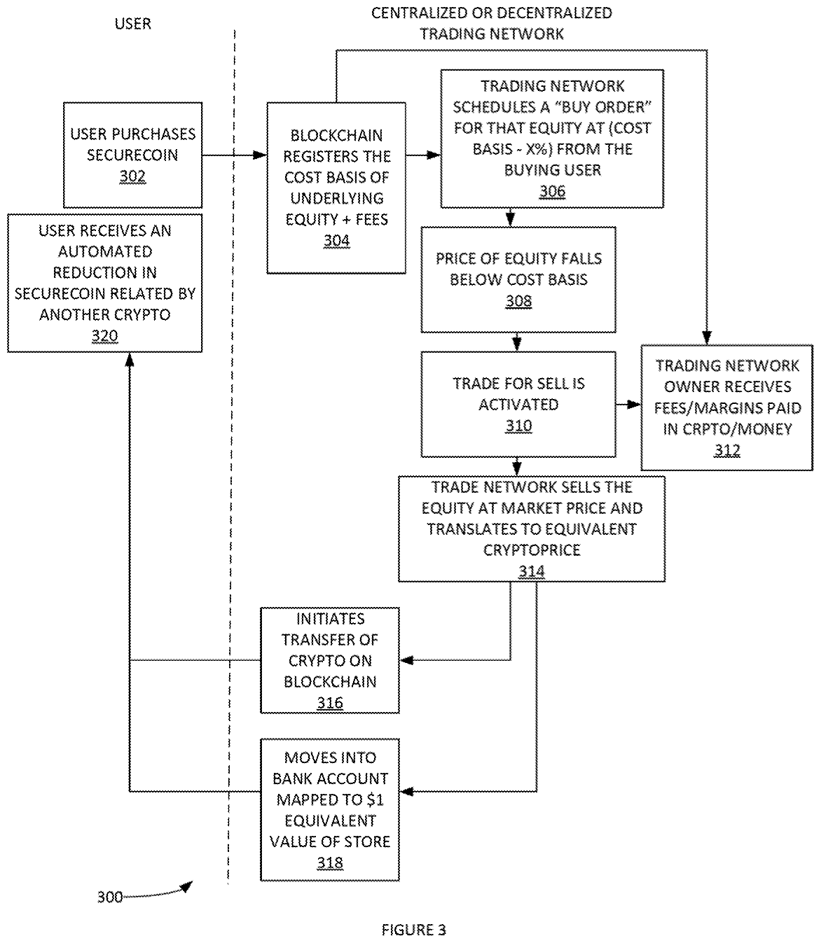

FIG. 3 illustrates an example process 300 for implementing a stop loss order on a secure token/coin (e.g. SECURECOIN, etc.), according to some embodiments. Process 300 can be used to protect the downside risk of a SECURECOIN purchaser.

In step 302, a user purchases SECURECOIN. In step 304, a blockchain system registers the cost basis of underlying equity plus the fees. In step 306, trading network schedules a “buy order” for that equity at (Cost basis-x %) from the buying user. In step 308, process 300 detects that the price of equity falls below cost basis. In step 310, a trade for sell is activated. In step 312, a trading network owner receives fees/margins paid in cryptocurrency and/or money. In step 314, the trade network sells the equity at market price and translates to equivalent cryptocurrency price. In step 316, process 300 initiates transfer of cryptocurrency on the blockchain. In parallel to step 316, instep 318, process 300 moves into bank account mapped to a dollar (and/or other hard currency) equivalent value of the store. In step 320, the user receives an automated reduction in SECURECOIN related by another cryptocurrency.

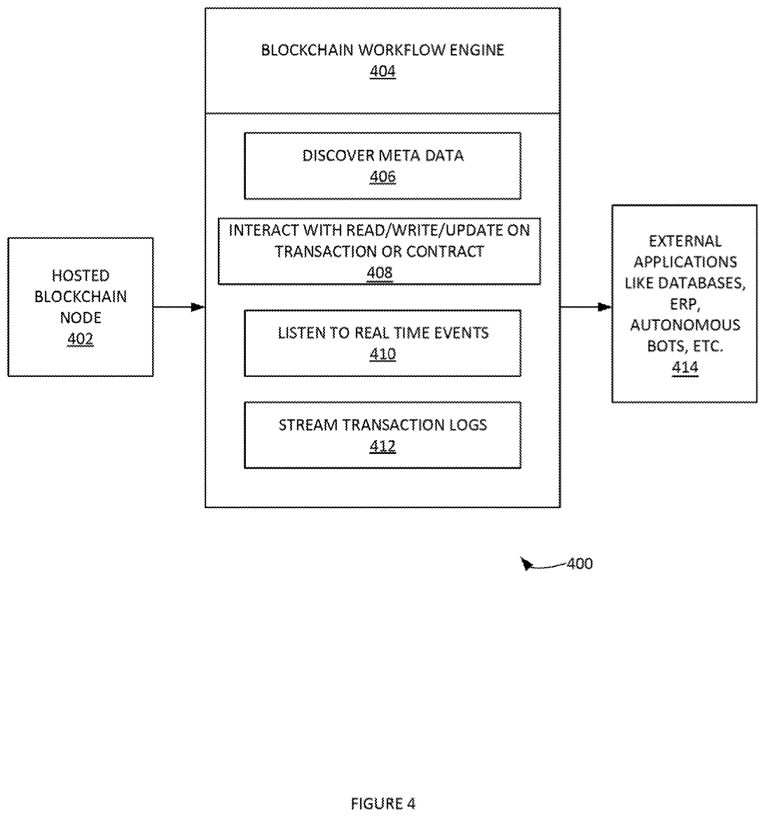

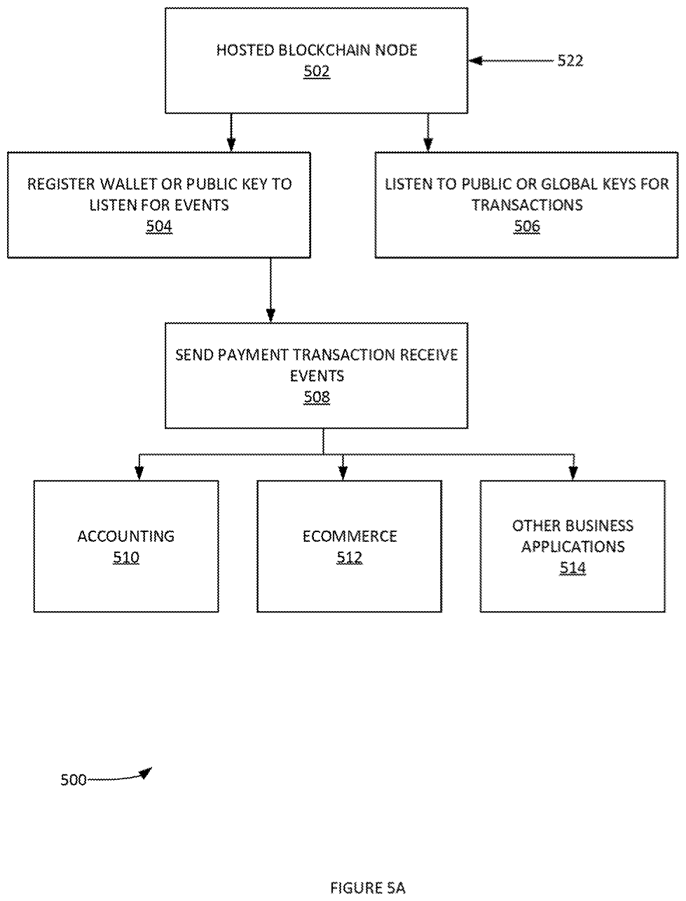

FIG. 4 illustrates an example process 400 for implementing a blockchain workflow engine, according to some embodiments. Blockchain workflow engine 404 can include an integration engine that can read metadata of any blockchain contract. Blockchain workflow engine 404 can query data from a contract globally, public key account or other filters Blockchain workflow engine 404 can write to contract by either interfacing with an external wallet or by storing data within its database. Blockchain workflow engine 404 can listen to events (e.g. a buy order that occurs, a sell that occurs, etc.) on a blockchain globally or by public keys to and transform data to push to another application. This can be done to adjust reserve values.

Blockchain workflow engine 404 can act as a bridge between two (2) or more blockchains to transfer value based on rules or contracts. Blockchain workflow engine 404 can provide the ability to run within a decentralized public network, private, permissioned on any other blockchain network.

Blockchain workflow engine 404 can interface with a hosted blockchain node 402 and external applications 414. External applications 414 can include various modules such as, inter alia: databases, ERP, autonomous bots, etc.

Blockchain workflow engine 404 can include various modules 406-412. These modules can implement blockchain workflows. For example, blockchain workflow engine 404 can discover metadata 406. Blockchain workflow engine 404 can interact with read/write/update operations on transaction or contract 408. Blockchain workflow engine 404 can listen to real time events 410. Blockchain workflow engine 404 can stream transaction logs 412.

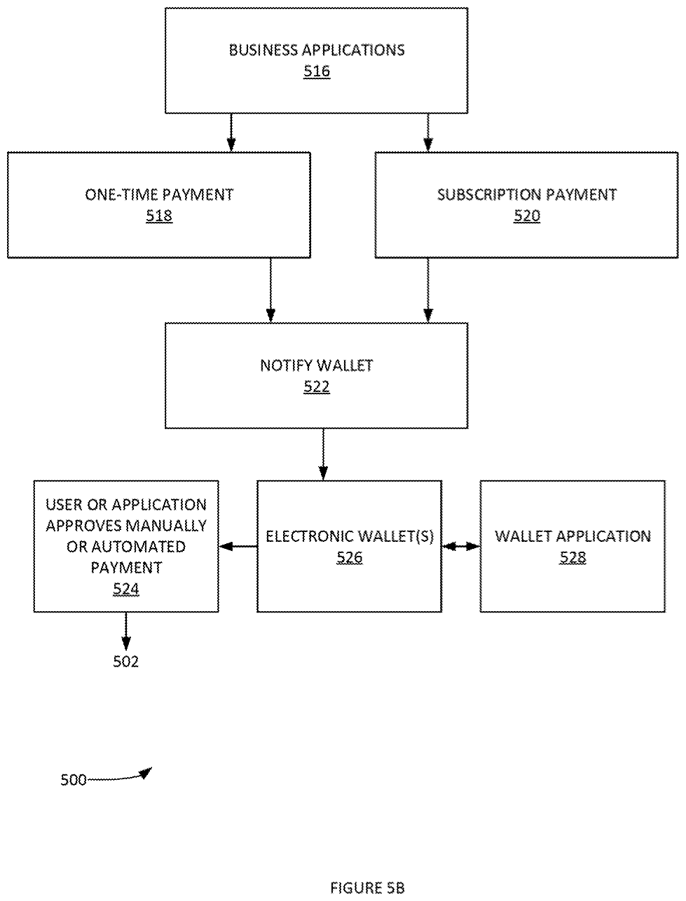

FIGS. 5 A-B illustrate an example process 500 for implementing blockchain ERP integration, according to some embodiments. In step 502, process 500 can host a blockchain node. In step 504, process 500 can register wallet or public key to listen for events. In step 506, process 500 can listen to public or global keys for transactions. After step 504, process 500 can proceed to step 508. In step 508, process 500 can send payment transaction receive events. Step 508 can utilize various platforms/applications such as, inter alia: accounting applications 510, ecommerce platforms 512, other business applications, 514.

In step 516, process 500 can implement various business applications. In step 518, process 500 can implement a one-time payment and/or in step 520, process 500 can implement a subscription payment plan. In step 522, a digital wallet can be notified (e.g. using an electronic wallet 526, a wallet application 528, etc.). In step 524, the user or application (manually or automatically) approves payment. Process 500 can return to step 502.

### EXAMPLE COMPUTING SYSTEMS

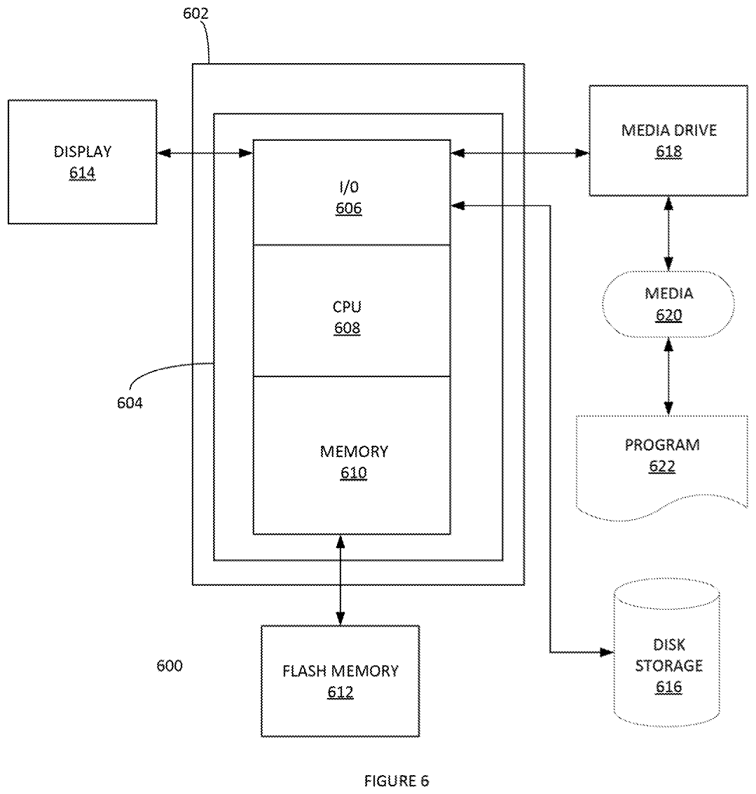

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. In another example, computing system 600 can be configured as a mobile device and include such systems as may be typically included in a mobile device such as GPS systems, gyroscope, accelerometers, cameras, etc.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for implementing security-backed cryptocurrency comprising:
implementing various user verifications/registrations enable a user to provide the user's banking account details a user can purchase the SECURECOIN;
generating SECURECOIN using specified block-chain systems;
depositing a specified percentage (X %) of the purchases in fiat/crypto to a bank account
setting 100-X % of the purchases equity at next market price;
adjusting reserves based on reserve equity;
notifying a specified trust authority and/or update information on a public web site providing SECURECOIN-related information; and
adjusting reserves by selling equity to match a token cost basis;
detecting when a bank account falls below Y % of net asset.
